(19) United States
(12) Patent Application Publication
(10) Pub. No.: US 2025/0170685 A1
(43) Pub. Date: May 29, 2025

(54) CHEMICAL MECHANICAL POLISHING APPARATUS

(71) Applicant: SAMSUNG ELECTRONICS CO., LTD., Suwon-si (KR)

(72) Inventors: Seyun Park, Suwon-si (KR); Donghoon Kwon, Suwon-si (KR)

(21) Appl. No.: 18/672,308

(22) Filed: May 23, 2024

(30) Foreign Application Priority Data
Nov. 24, 2023 (KR) 10-2023-0165338

(51) Int. Cl. B24B 37/24; B24B 49/00; B24B 49/02

(52) U.S. Cl. CPC B24B 37/24; B24B 49/003; B24B 49/02

(57) ABSTRACT

A chemical mechanical polishing apparatus includes a polishing platen, a polishing pad disposed on an upper surface of the polishing platen, a polishing head disposed on the polishing pad and including a wafer accommodating portion supporting a wafer to contact an upper surface of the polishing pad, the polishing pad having a hole disposed on a track through which the polishing head passes on the upper surface of the polishing pad, an acoustic sensor disposed to fill the hole of the polishing pad and including a porous piezoelectric structure formed of piezoelectric particles and first and second electrodes connected to the porous piezoelectric structure, and a processor configured to detect a polishing endpoint based on acoustic signals received from the first and second electrodes of the acoustic sensor.

### CROSS-REFERENCE TO RELATED APPLICATION(S)

This application claims priority to Korean Patent Application No. 10-2023-0165338 filed on Nov. 24, 2023, in the Korean Intellectual Property Office, the disclosure of which is incorporated herein by reference in its entirety.

### BACKGROUND

The present disclosure relates to a chemical mechanical polishing apparatus.

Semiconductor devices may be manufactured through various processes. For example, the manufacturing processes of semiconductor devices may include a photolithography process, an etching process, a deposition process, and the like for wafers. A process of planarizing a surface of the wafer may be required prior to each process. A wafer polishing process may be performed in various manners. For example, a chemical mechanical polishing (CMP) process may be used to planarize the wafer.

### SUMMARY

The present disclosure provides a chemical mechanical polishing apparatus for improving the reliability of a polishing process.

According to a first general aspect of the present disclosure, a chemical mechanical polishing apparatus includes: a polishing platen; a polishing pad disposed on an upper surface of the polishing platen; a polishing head disposed on the polishing pad and including a wafer accommodating portion supporting a wafer to contact an upper surface of the polishing pad, the polishing pad having a hole disposed on a track through which the polishing head passes on the upper surface of the polishing pad; an acoustic sensor disposed to fill the hole of the polishing pad and including a porous piezoelectric structure formed of piezoelectric particles and first and second electrodes connected to the porous piezoelectric structure; and a processor configured to detect a polishing endpoint based on acoustic signals received from the first and second electrodes of the acoustic sensor.

According to a second general aspect of the present disclosure, a chemical mechanical polishing apparatus includes: a polishing platen; a polishing pad disposed on an upper surface of the polishing platen; a polishing head disposed on the polishing pad and including a wafer accommodating portion supporting a wafer to contact an upper surface of the polishing pad, the polishing pad having a plurality of holes arranged in a radial direction of the polishing pad on a track through which the polishing head passes on the upper surface of the polishing pad; a plurality of acoustic sensors respectively arranged to fill the plurality of holes, respectively including a porous piezoelectric layer including piezoelectric particles and first and second electrodes connected to the porous piezoelectric layer; and a processor configured to detect a polishing endpoint based on acoustic signals received from the plurality of acoustic sensors.

According to a third general aspect of the present disclosure, a chemical mechanical polishing apparatus includes: a polishing platen; a polishing pad disposed on an upper surface of the polishing platen; a polishing head disposed on the polishing pad and including a wafer accommodating portion supporting a wafer to contact an upper surface of the polishing pad, the polishing pad having a hole disposed in a track through which the polishing head passes on the upper surface of the polishing pad; an acoustic sensor disposed to fill the hole of the polishing pad and including a porous piezoelectric structure having a plurality of piezoelectric layers stacked in a thickness direction of the polishing pad and having different porosities and first and second electrodes connected to the porous piezoelectric structure; and a processor configured to detect a polishing endpoint based on acoustic signals received from the first and second electrodes of the acoustic sensor.

### BRIEF DESCRIPTION OF DRAWINGS

FIG. 1 is a schematic perspective view of an example of a chemical mechanical polishing apparatus.

FIG. 2 is a schematic plan view of an example of a chemical mechanical polishing apparatus.

FIG. 3 is a partial cross-sectional view of the chemical mechanical polishing apparatus of FIG. 2 taken along line I-I′.

FIG. 4 is a schematic perspective view illustrating an example of an acoustic sensor applicable to the chemical mechanical polishing apparatus of FIG. 1.

FIG. 5 is a process flowchart illustrating an example of a method of manufacturing a porous piezoelectric structure of an acoustic sensor.

FIGS. 6 and 7 are schematic perspective views illustrating various examples of acoustic sensors that may be employed in a chemical mechanical polishing apparatus.

FIG. 8 is a cross-sectional view illustrating an example of a chemical mechanical polishing apparatus.

FIG. 9 is a schematic plan view of an example of a chemical mechanical polishing apparatus.

FIGS. 10A and 10B are schematic perspective views illustrating examples of acoustic sensors that may be employed in a chemical mechanical polishing apparatus.

FIG. 11 is a partial plan view illustrating an example of a track region of a chemical mechanical polishing apparatus.

FIG. 12 is a schematic perspective view illustrating examples of acoustic sensors that may be employed in a chemical mechanical polishing apparatus.

FIG. 13 is a partial plan view illustrating an example of a track region of a chemical mechanical polishing apparatus. and

FIGS. 14A and 14B are schematic perspective views illustrating examples of acoustic sensors that may be employed in a chemical mechanical polishing apparatus.

### DETAILED DESCRIPTION

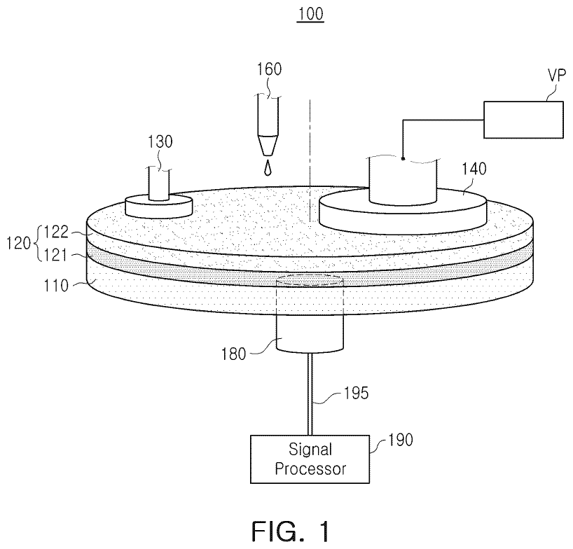

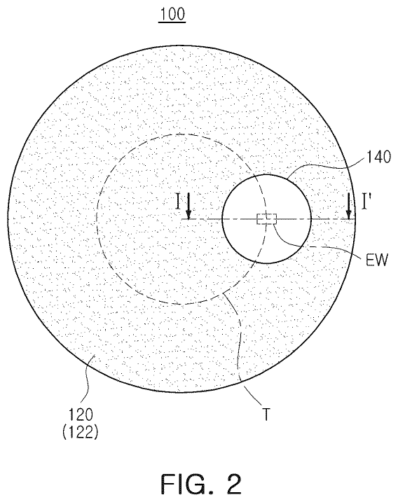

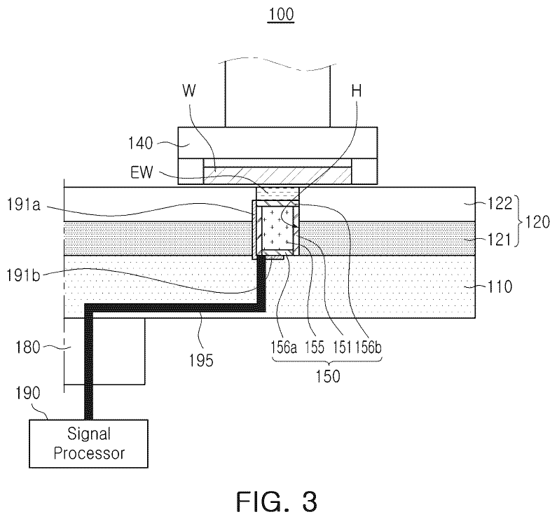

FIG. 1 is a schematic perspective view of an example of a chemical mechanical polishing apparatus, FIG. 2 is a schematic plan view of the chemical mechanical polishing apparatus, and FIG. 3 is a partial cross-sectional view of the chemical mechanical polishing apparatus of FIGS. 1 and 2, taken along line I-I′.

Referring to FIG. 1, a chemical mechanical polishing apparatus 100 includes a polishing platen 110, a polishing pad 120 on the polishing platen 110, a polishing head 140 disposed to face one surface of the polishing pad 120, a vacuum pump (VP) connected to the polishing head 140, a conditioning disk 130, and a slurry supply unit 160.

The chemical mechanical polishing apparatus 100 may polish a device and planarize one surface of a wafer (“W” in FIG. 3) through a chemical mechanical polishing (CMP) process. For example, the wafer W to be polished may be a semiconductor wafer, such as a silicon wafer, but is not limited thereto.

The polishing platen 110 may support the polishing pad 120. The polishing pad 120 may be disposed on an upper surface of the polishing platen 110. The polishing platen 110 may have a circular shape in plan view. For example, the polishing platen 110 may have a disk shape. For example, a diameter of the polishing platen 110 may be about 700 mm to about 900 mm. The polishing platen 110 may rotate about a central axis, perpendicular to the upper surface of the polishing pad 120. Rotation of the polishing platen 110 may be implemented by a separate driving unit. For example, the driving unit may include an electric motor or a hydraulic motor.

The polishing pad 120 may be located on the polishing platen 110. For example, the polishing pad 120 may be detachably coupled to the polishing platen 110. The polishing pad 120 may have a circular shape in plan view. For example, the polishing pad 120 may have a disk shape corresponding to the polishing platen 110. The polishing pad 120 may polish a lower surface of the wafer W. The polishing pad 120 is a member performing mechanical polishing and may uniformly planarize the surface of the wafer W. The polishing pad 120 may be located on the polishing platen 110 and may rotate by driving the polishing platen 110.

The polishing pad 120 may include a first polishing pad 121 disposed on the polishing platen 110 and a second polishing pad 122 disposed on the first polishing pad 121. The first and second polishing pads 121 and 122 may include different materials (or porosities).

The polishing pad 120 may include a hole H in which an acoustic sensor 150 is accommodated. The hole H may be formed in a track T, e.g., a path, through which the polishing head 140 passes on an upper surface of the polishing pad 120.

Referring to FIG. 3, the hole H is illustrated as penetrating through the polishing pad 120. However, In some implementations, the hole H may be formed to penetrate through only the second polishing pad 122 or may extend to a portion of the polishing pad 122.

The acoustic sensor 150 introduced in the present example may include a porous piezoelectric structure 155 having a sufficient volume to substantially fill the space within the hole H. The configuration and arrangement of the acoustic sensor 150 may significantly increase endpoint detection (EPD) sensitivity by minimizing the attenuation of acoustic signals occurring due to a change in wafer film quality during the CMP process. A detailed description of this will be given below.

Referring to FIGS. 1 and 3, the polishing head 140 may support the wafer W. The polishing head 140 may be configured to rotate and move, while coupled to the wafer W. During polishing, the wafer W may be moved, while rotating on the polishing pad 120 by the polishing head 140. The polishing head 140 may descend toward the polishing pad 120 to bring a lower surface (i.e., a surface to be polished) of the wafer W into contact with an upper surface of the polishing pad 120.

In the present example, the polishing head 140 may accommodate the wafer W using a vacuum suction method using a vacuum pump VP. The vacuum pump VP may be connected to the polishing head 140 to provide vacuum pressure to the polishing head 140. The wafer W may be adsorbed by the polishing head 5 by the vacuum pressure provided from the vacuum pump VP. However, the present inventive concept is not limited thereto, and the polishing head 140 may be coupled to the wafer W by various other method.

The conditioning disk 130 may move on polishing pad 120. The conditioning disk 130 may selectively contact the upper surface of the polishing pad 120. While the polishing pad 120 rotates, the conditioning disk 130 may contact the upper surface of the polishing pad 120. The conditioning disk 130 may change a surface condition of the upper surface of the polishing pad 120. For example, the conditioning disk 130 may grind the upper surface of the polishing pad 120. That is, the conditioning disk 130 may improve the condition of the polishing pad 120 by polishing the polishing pad 120 itself. The conditioning disk 130 may contact the polishing pad 120 during the polishing process for the wafer W or may contact the polishing pad 120 after the polishing process for the wafer W is completed. The slurry supply unit 160 may supply slurry to the polishing pad 120. More specifically, the slurry supply unit 160 may supply slurry to the upper surface of the polishing pad 120 so that the polishing process for the wafer W proceeds smoothly.

Referring to FIG. 3, the acoustic sensor 150 may include the porous piezoelectric structure 155 and first and second electrodes 156a and 156b respectively disposed on both surfaces of the porous piezoelectric structure 155. The acoustic sensor 150 may be disposed in the hole H and may further include a housing 151 surrounding the porous piezoelectric structure 155. A window EW (also referred to as an “EPD window”), e.g., a layer, covering an upper surface of the acoustic sensor 150 may be disposed in the hole H of the polishing pad 120. The housing 151 and the window EW may secure the acoustic sensor 180 accommodated in the hole H and protect the acoustic sensor 150 from a physical/chemical shock that may occur during the polishing process.

The polishing pad 120 may include a polyurethane resin and have a porous structure. In this specification, the porous structure of the polishing pad 120 refers to a structure including a plurality of pores on the surface or inside the pad. In some implementations, the window EW may include a material (e.g., a polyurethane resin) the same as or similar to the polishing pad 120. Meanwhile, unlike the polishing pad 120, the window EW may not include a porous structure on the surface or inside. The window EW may serve as a medium through which sound waves or vibrations generated during the polishing process are transmitted to a piezoelectric structure inside the acoustic sensor 150. If the surface or inside of the window EW includes a porous structure, sound waves or vibrations generated during the polishing process may not be easily transmitted into the acoustic sensor 180. Therefore, unlike the polishing pad 120, the window EW may not include a porous structure on the surface or inside, and thus, sound waves or vibrations generated during the polishing process may be easily transmitted to the acoustic sensor 150.

As described above, referring to FIG. 3, the porous piezoelectric structure 155 may have a sufficient volume so that the internal space of the hole H is almost filled. The internal space of the hole H is filled with a solid medium (e.g., a piezoelectric material) advantageous for sound wave transmission, and thus, sound waves generated during the polishing process may be effectively transmitted to the acoustic sensor 150. In this manner, the chemical mechanical polishing apparatus 100 may provide advantageous conditions for electron generation by sound waves in the acoustic sensor 150, compared to a form in which the empty space of the hole H remains.

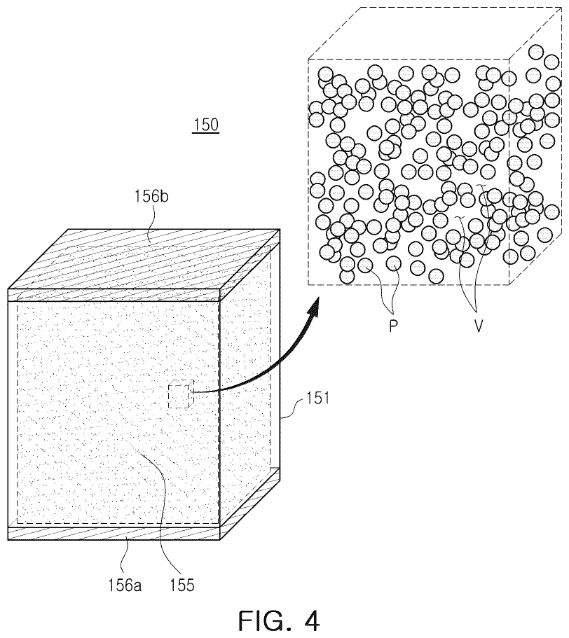

The acoustic sensor 150 includes the porous piezoelectric structure 155 as a piezoelectric material. FIG. 4 is a schematic perspective view illustrating an example of an acoustic sensor employed in the chemical mechanical polishing apparatus of FIG. 1.

Referring to FIG. 4, the porous piezoelectric structure 155 employed in the present example may include irregularly agglomerated piezoelectric particles P, and the “porosity” of the piezoelectric structure 155 may be provided by pores V between particles. For example, the piezoelectric particle P may be a lead zirconate titanate (PZT)-based piezoelectric particle.

By increasing the porosity of the piezoelectric material employed in the acoustic sensor 150, a difference in acoustic impedance between air (e.g., gas phase) and slurry (e.g., liquid phase) may be reduced, thereby reducing reflection of sound energy. In addition, the porous piezoelectric structure 155 may increase a piezoelectric coefficient because a surface area of the piezoelectric material is increased.

In this manner, the porous piezoelectric structure 155 employed in the present example may increase the piezoelectric coefficient of the acoustic sensor 150, while reducing the difference in acoustic impedance. As a result, the acoustic sensor 150 may have significantly improved sensitivity due to the increased amount of charge generated by sound waves.

If the porosity of the porous piezoelectric structure 155 is high, mechanical strength may be reduced. For example, the porous piezoelectric structure 155 may range from 5 to 95%. A size of the pores V may vary depending on the size of the particle, e.g., the pores V may each be in the range of 0.001 to 10 μm.

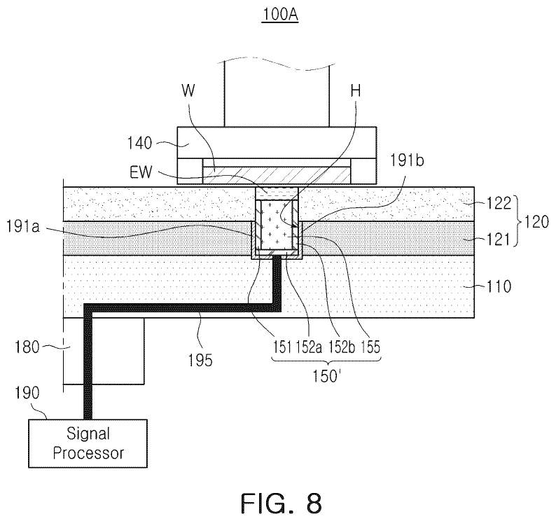

In the present example, the first electrode 156a and the second electrode 156b may be disposed on the lower and upper surfaces of the porous piezoelectric structure 155, respectively. A signal cable 195 is installed on the polishing platen 110, and the first and second electrodes 156a and 156b may be connected to the signal cable 195 by first and second interconnection lines 191a and 191b, respectively. In this connection, the first and second electrodes 156a and 156b may transmit an electrical signal (or an acoustic signal) generated in the porous piezoelectric structure 155 by sound waves to a signal processor 190 through the first and second interconnection lines 191a and 191b and the signal cable 195. The signal processor 190 may be configured to detect a polishing endpoint based on the acoustic signal received from the acoustic sensor 150. Placement and connection of the acoustic sensor may be implemented in a variety of different manners (see, e.g., FIG. 8).

At least one of the first and second electrodes 156a and 156b may include a conductive polymer material. In the present example, the second electrode 156b may include a conductive polymer material. The second electrode 156b may include the same material as that of the window EW in contact with the second electrode 156b. For example, the second electrode 156b may include a conductive polymer material, such as PEDOT: PSS (poly(2,3-dihydrothieno-1,4-dioxin)-poly(styrenesulfonate)). In some implementations, the second electrode 156b may be formed integrally with the window EW. The first electrode 156a may include a conductive polymer material similar to the second electrode 156b but may also include metals.

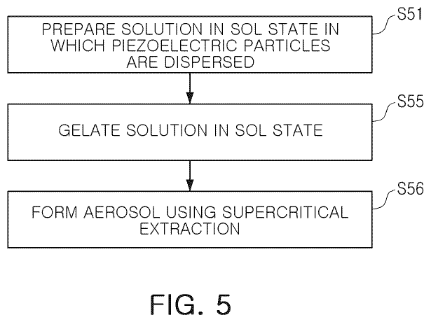

The porous piezoelectric structure 155 employed in the present example may be manufactured using an aerogel method. FIG. 5 is a process flowchart illustrating an example of a method of manufacturing a porous piezoelectric structure of an acoustic sensor.

Referring to FIG. 5, a sol, e.g., a stable colloidal particle, may be formed from a precursor for a desired piezoelectric material (S51), and a solid gel may be formed through a hydrolysis reaction and condensation polymerization reaction of the sol solution (S55). Porosity may vary depending on a drying method to remove the solution. For example, a porous piezoelectric structure having a relatively high porosity (e.g., 50% or more, or 80% or more) may be obtained using an aerosol method of extracting a liquid component with supercritical fluid (e.g., CO₂) (S56). By changing the drying method of the sol solution, porous piezoelectric structures having a different porosity may be obtained. For example, a porous piezoelectric structure having a relatively low porosity (e.g., 30% to 50%) may be obtained using a xerogel method of heating in an electric furnace.

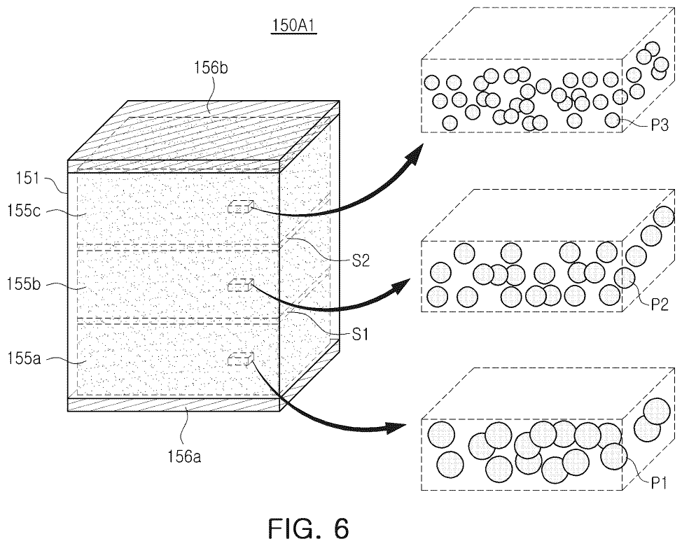

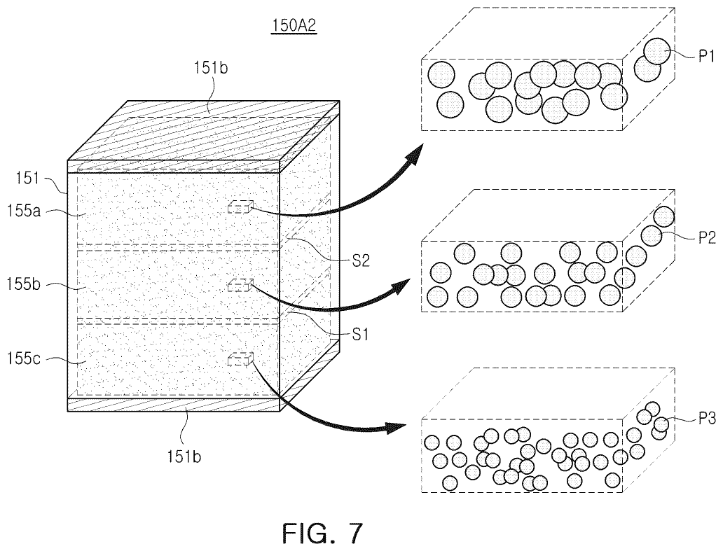

The acoustic sensor for detecting the polishing endpoint may have various different structures. For example, the porous piezoelectric structure may include a plurality of piezoelectric layers stacked in a thickness direction of the polishing pad, and the plurality of piezoelectric layers may include piezoelectric particles having different porosities. FIGS. 6 and 7 are schematic perspective views illustrating various examples of acoustic sensors that may be employed in a chemical mechanical polishing apparatus.

First, referring to FIG. 6, an acoustic sensor 150A1 may include multilayer piezoelectric layers 155a, 155b, and 155c substantially filling an internal space of a hole and first and second electrodes 156a and 156b respectively disposed on opposing surfaces of the piezoelectric layers 155a, 155b, and 155c. The multilayer piezoelectric structure employed in the present example includes first to third piezoelectric layers 155a, 155b, and 155c sequentially stacked in the thickness direction of a polishing pad.

In the present example, the first piezoelectric layer 155a may have a first porosity, the second piezoelectric layer 155b may have a second porosity lower than the first porosity, and the third piezoelectric layer 155c may have a third porosity lower than the second porosity. In this manner, the porosities of the piezoelectric layers are lowered (e.g., the piezoelectric particles become dense) toward the surface of the polishing pad (120 of FIG. 3), thereby preventing signal cancellation due to damping and increasing sensitivity.

In the present example, the porosity may be adjusted using the sizes of piezoelectric particles P1, P2, and P3. Specifically, the first to third piezoelectric layers 155a, 155b, and 155c are formed through the same process (e.g., aerosol). During this process, however, the sizes of particles thereof are varied, thereby forming the first to third piezoelectric layers 155a, 155b, and 155c to have different porosities.

The housing 151 employed in the present example may surround the multilayer piezoelectric structure 155 and may include partition structures S1 and S2 between each of the first to third piezoelectric layers 155a, 155b, and 155c.

Referring to FIG. 7, an acoustic sensor 150A2 may include a multilayer piezoelectric structure similar to the acoustic sensor 150A1 according to the previous example, but the porosities of the piezoelectric layers are arranged opposite to the previous example. Specifically, the first piezoelectric layer 155c disposed at the bottom may have a first porosity, the second piezoelectric layer 155b may have a second porosity higher than the first porosity, and the third piezoelectric layer 155c may have a third porosity higher than the second porosity.

In this manner, the porosities of the piezoelectric layers increase toward the surface of the polishing pad (120 of FIG. 3), thereby increasing the amount of charges due to sound stress to improve EPD sensitivity.

In the multilayer piezoelectric structure of the present example, the porosity of each of the piezoelectric layers 155a, 155b, and 155c may be adjusted using the size of the piezoelectric particles P1, P2, and P3, similar to the previous example. As such, in the acoustic sensors 150A1 and 150A2 illustrated in FIGS. 6 and 7, the porosity of each piezoelectric layer is adjusted using the size of the piezoelectric particles. However, the piezoelectric layers may be formed to have the same size and piezoelectric particles of the same material but may have different porosities by varying manufacturing methods.

For example, in the method of manufacturing a piezoelectric material using a sol-gel method, each piezoelectric layer may be formed to have a different porosity by varying a liquid extraction method. Specifically, a piezoelectric layer having a relatively high porosity may be formed using an aerosol, and a piezoelectric layer having a relatively low porosity may be formed using an xerogel (see FIG. 5). In addition, a piezoelectric layer having a low porosity (30% or less) may be formed using a precipitation method.

The acoustic sensors 150A1 and 150A2 illustrated in FIGS. 6 and 7 are illustrated as including the multilayer piezoelectric structures including three piezoelectric layers 155a, 155b, and 155c, but may include two or a different number of piezoelectric layers. In some implementations, a plurality of piezoelectric layers may be formed to have different thicknesses.

FIG. 8 is a cross-sectional view illustrating an example of a chemical mechanical polishing apparatus.

Referring to FIG. 8, a chemical mechanical polishing apparatus 100A has a structure similar to that of the chemical mechanical polishing apparatus 100 illustrated in FIGS. 1 and 4, except that the arrangement of an acoustic sensor 150′ and an electrode connection structure are different. Otherwise, unless otherwise stated, the components of the present example may be understood with reference to the description of the same or similar components of the chemical mechanical polishing apparatus 100 illustrated in FIGS. 1 to 4.

The acoustic sensor 150′ may include first and second electrodes 156a and 156b respectively disposed on opposing side surfaces of the porous piezoelectric structure 155. The arrangement of the first and second electrodes 156a and 156b may be more easily connected to the signal cable 195 installed on the polishing platen 110. Since the first and second electrodes 156a and 156b are located on the polishing platen, they may be connected to the signal cable 195 through the first and second interconnection lines 191a and 191b.

The housing 151 of the acoustic sensor 150′ may be configured to surround a lower surface and both remaining side surfaces of the porous piezoelectric structure 155. The housing 151 may be configured to open the upper surface of the porous piezoelectric structure 155, and the upper surface of the porous piezoelectric structure 155 may be configured to directly contact the window EW.

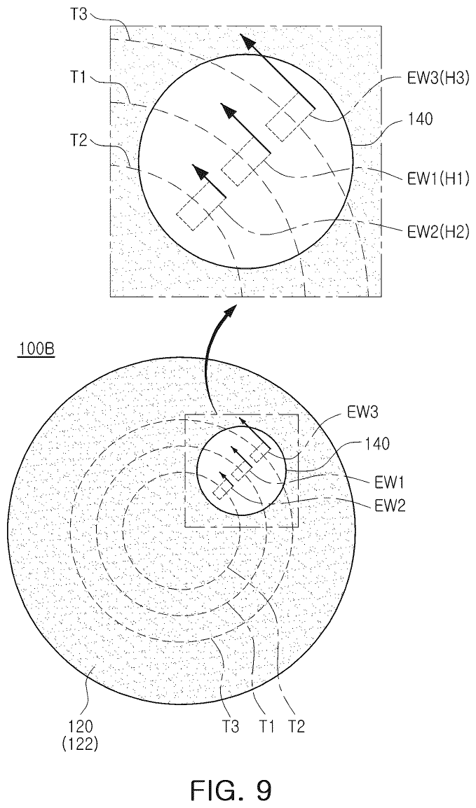

FIG. 9 is a schematic plan view of an example of a chemical mechanical polishing apparatus.

Referring to FIG. 9, a chemical mechanical polishing apparatus 100B may be understood as having a structure similar to that of the chemical mechanical polishing apparatus 100 illustrated in FIGS. 1 and 4, except that the chemical mechanical polishing apparatus 100B includes a plurality of holes H1, H2, and H3 and each of the plurality of holes H1, H2, and H3 has an acoustic sensor 150D1 or 150D2 for each EPD. Otherwise, unless otherwise stated, the components of the present example may be understood with reference to the description of the same or similar components of the chemical mechanical polishing apparatus 100 illustrated in FIGS. 1 to 4.

The hole for the acoustic sensor employed in the present example may include a plurality of holes, that is, first to third holes H1, H2, and H3, in a track region through which the polishing head 140 passes. The first to third holes H1, H2, and H3 may be arranged in a radial direction of the upper surface of the polishing pad 120.

The first hole H1 is located below a first track T1, e.g., coincident with the track T1 from a plan view, adjacent to the center of the track region, and the second and third holes H2 and H3 are located on the second and third tracks T2 and T3 respectively adjacent to the inner and outer peripheries of the track region. Acoustic sensors may be disposed below respective windows EW1, EW2, and EW3 in the first to third holes H1, H2, and H3 in different positions on the track.

In this manner, by installing a plurality of acoustic sensors in different positions (e.g., center and edge) of the track region and increasing the sensitivity of the acoustic signal, especially, in the edge region, sound waves due to a change in wafer film quality may be detected more precisely.

In some implementations, the second and third acoustic sensors located in the second and third tracks T2 and T3 as edge regions may be configured to have a higher sensitivity than the sensitivity of the first acoustic sensor located in the first track T1, the center.

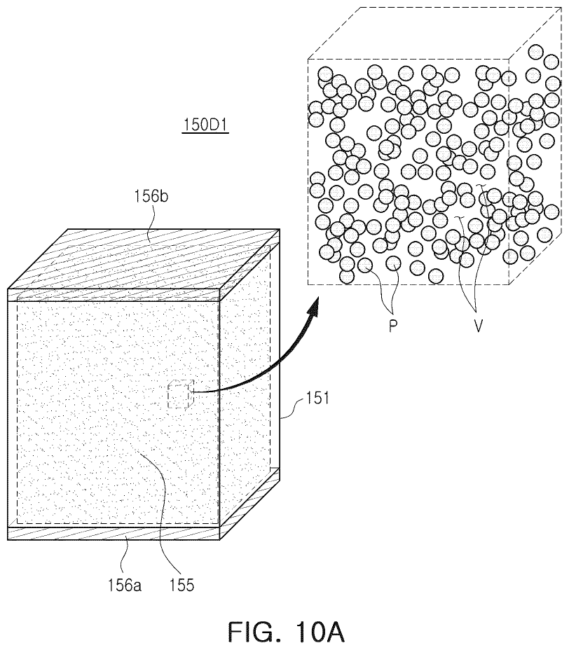

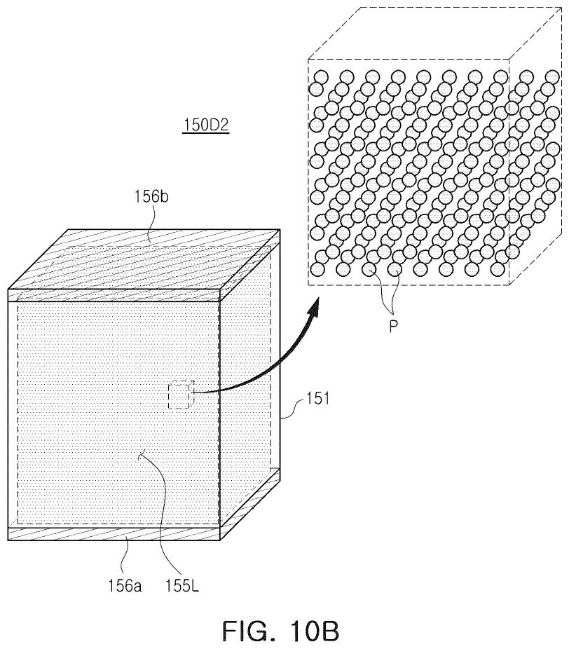

For example, the second and third acoustic sensors may employ an acoustic sensor 150D1 illustrated in FIG. 10A, and the first acoustic sensor may employ an acoustic sensor 150D2 illustrated in FIG. 10B.

Referring to FIG. 10A, similar to the acoustic sensor illustrated in FIG. 4, the acoustic sensor 150D1 includes a porous piezoelectric structure 155 having a sufficient volume to substantially fill the spaces of the second and third holes H2 and H3. The porous piezoelectric structure 155 employed in the present example may include piezoelectric particles P aggregated to have the pore V between particles.

As described above, the spaces of the second and third holes H2 and H3 are filled with a solid medium (e.g., a piezoelectric material) advantageous for sound wave transmission, so that sound waves generated during the polishing process may be effectively transmitted to the acoustic sensor 150. In addition, the porous piezoelectric structure 155 may increase the piezoelectric coefficient because a surface area of the piezoelectric material is increased.

In this manner, the porous piezoelectric structure 155 employed in the present example may increase the piezoelectric coefficient of the acoustic sensor 150 while reducing the difference in acoustic impedance, and as a result, the acoustic sensor 150 may increase the amount of charges generated by sound waves, thereby having significantly improved sensitivity.

Meanwhile, referring to FIG. 10B, the acoustic sensor 150D2 includes a piezoelectric structure 155L having a sufficient volume to substantially fill the space within the first hole H1 but may include piezoelectric particles having a relatively low porosity or a crystal structure. The piezoelectric structure 155L of the acoustic sensor 155D2 has a relatively small specific surface area compared to the porous piezoelectric structure 155 of the acoustic sensor 155D1 according to the previous example, and therefore has a relatively low piezoelectric coefficient. Accordingly, the acoustic sensor 155D2 may have lower sensitivity than the acoustic sensor 155D1 compared to the previous example.

Therefore, the low-sensitivity acoustic sensor 150D2 may be installed in the first hole H1 located in the center track T1, e.g., from a plan view, of the track region, and the high-sensitivity acoustic sensor 150D1 may be installed in the second and third holes H2 and H3 located in the edge tracks T2 and T3 of the track region. The acoustic sensor 150D2 illustrated in FIG. 10B is illustrated as having a crystallized piezoelectric body, but an acoustic sensor having a relatively low sensitivity may be manufactured to include a porous piezoelectric structure having a different porosity.

In some implementations, the first acoustic sensor located in the first hole may include a first piezoelectric layer having a first porosity, and the second and third acoustic sensors respectively located in the second and third holes may include second and third piezoelectric layers having second and third porosities higher than the first porosity.

In another example, the first acoustic sensor located in the first hole may include a first piezoelectric layer having a first porosity, and the second and third acoustic sensors respectively located in the second and third holes may include second and third piezoelectric layers having second and third porosities lower than the first porosity.

In some implementations, the porosity for a difference in sensitivity may be implemented differently using the size of the particles, as described above with reference to FIGS. 6 and 7. Specifically, the acoustic sensor installed in the first hole may include a piezoelectric structure having small piezoelectric particles, and the acoustic sensor installed in the second and third holes may include a piezoelectric structure having large piezoelectric particles. However, the present disclosure is not limited thereto, and in another example, acoustic sensors having the same sensitivity may be installed even in holes in different positions.

In this manner, by introducing a plurality of acoustic sensors in different positions (particularly, edge regions) of the track region through which the polishing head passes on the upper surface of the polishing pad, sound waves generated due to changes in wafer film quality during the polishing process may be more effectively detected.

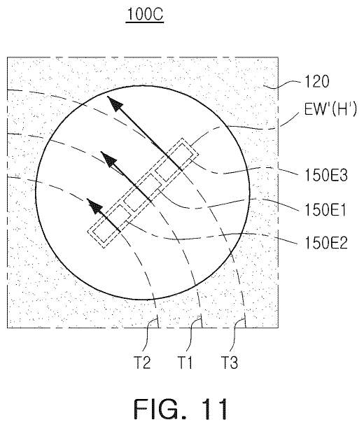

FIG. 11 is a partial plan view illustrating an example of a track region of a chemical mechanical polishing apparatus, which may be understood as a portion corresponding to an enlarged portion of the polishing pad illustrated in FIG. 10.

Referring to FIG. 11, a chemical mechanical polishing apparatus 100C has a structure similar to that of the chemical mechanical polishing apparatus 100 illustrated in FIGS. 1 and 4, except that the chemical mechanical polishing apparatus 100C has an expansion hole H′ extending in the radial direction and a plurality of acoustic sensors 150E1, 150E2, and 150E3) are installed in the expansion hole H′. Otherwise, unless otherwise stated, the components of the present example may be understood with reference to the description of the same or similar components of the chemical mechanical polishing apparatus 100 illustrated in FIGS. 1 to 4.

The expansion hole H′ employed in the present example is disposed in the track region through which the polishing head 140 passes and may extend in the radial direction of the upper surface of the polishing pad 120. The expansion hole H′ may be provided to pass through the first track T1 (from a plan view) adjacent to the center of the track region and the second and third tracks T2 and T3 adjacent to the inner and outer peripheries of the track region.

One window EW′ may be disposed in the expansion hole H′, and first to third acoustic sensors 150E1, 150E2, and 150E3 may be arranged in positions corresponding to the tracks T1, T2, and T3, respectively, below the window EW′.

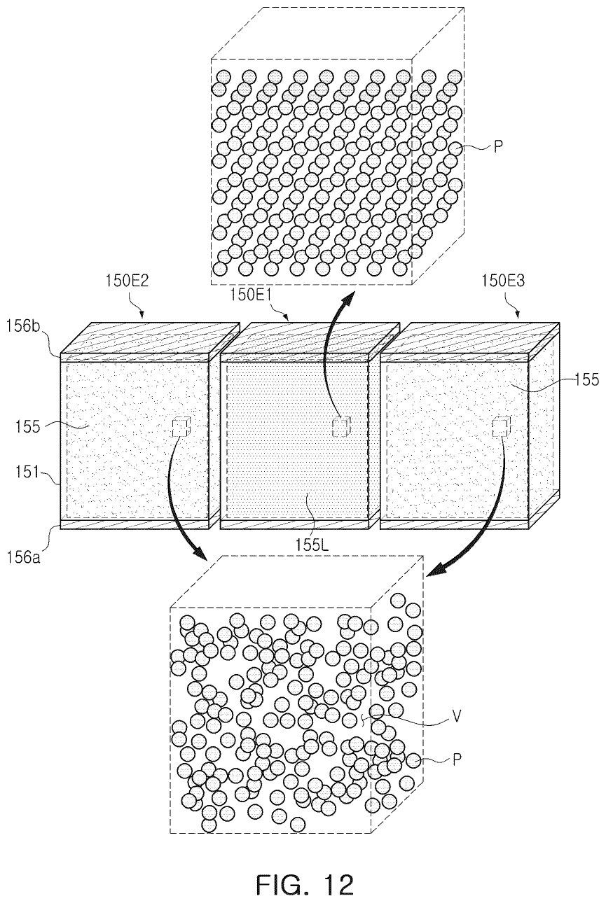

As illustrated in FIG. 12, the first to third acoustic sensors 150E1, 150E2, and 150E3 may function as electrically independent sensors by configuring the piezoelectric material together with the first and second electrodes 156a and 156b to be separated from each other. In some implementations, the first to third acoustic sensors 150E1, 150E2, and 150E3 may be provided as a single structurally integrated assembly using a single housing.

The first acoustic sensor 150E1 located below the first track T1, e.g., overlapping the first track T1 from a plan view, may be the low-sensitivity acoustic sensor described above with reference to FIG. 10B, and the second and third acoustic sensors 150E2 and 150E3 located on the second and third tracks T2 and T3, respectively, may be the high-sensitivity acoustic sensors described above with reference to FIG. 10A. In addition, the first acoustic sensor 150E1 is illustrated as having a crystallized piezoelectric body, but an acoustic sensor having relatively low sensitivity may be manufactured to include a porous piezoelectric structure having a different porosity.

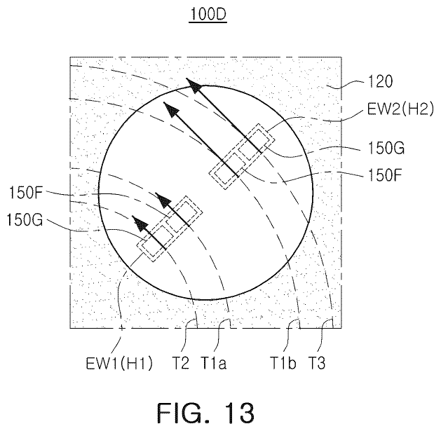

FIG. 13 is a partial plan view illustrating an example of a track region of a chemical mechanical polishing apparatus, and may be understood as a portion corresponding to the enlarged portion of the polishing pad illustrated in FIG. 10A and 10B.

Referring to FIG. 13, a chemical mechanical polishing apparatus 100D has a structure similar to that of the chemical mechanical polishing apparatus 100 illustrated in FIGS. 1 and 4, except that the chemical mechanical polishing apparatus 100D has two expansion holes H1′ and H2′ extending in the radial direction and first and second acoustic sensors 150F and 150G are installed in the first and second expansion holes H1′ and H2′, respectively. Otherwise, unless otherwise stated, the components of the present example may be understood with reference to the description of the same or similar components of the chemical mechanical polishing apparatus 100 illustrated in FIGS. 1 to 4.

The first and second expansion holes H1′ and H2′ employed in the present example may be arranged in the radial direction of the upper surface of the polishing pad 120 in the track region through which the polishing head 140 passes, and each may extend in the radial direction. The first expansion hole H1′ may be provided to, from a plan view, overlap a first inner track T1a adjacent to the center of the track region and a second track T2 adjacent to the inner periphery of the track region, and the second expansion hole H2′ may be provided to, from a plan view, overlap with a second inner track T1b adjacent to the center of the track region and a third track T3 adjacent to the outer periphery of the track region.

A first window EW1 is provided in the first expansion hole H1′, and first and second acoustic sensors 150F and 150G overlapping with the first internal track T1a and the second track T2 may be installed below the first window EW1. Similarly, a second window EW2 is provided in the second expansion hole H2′, and the first and second acoustic sensors 150F and 150G overlapping with the second internal track T1b and the third track T3 may be installed below the second window EW2.

In the present example, the first acoustic sensor 150F located on the first and second internal tracks T1a and T1b, respectively, may have a relatively low sensitivity, and the second acoustic sensor 150G located on the second and third internal tracks T2 and T3 may have a relatively high sensitivity.

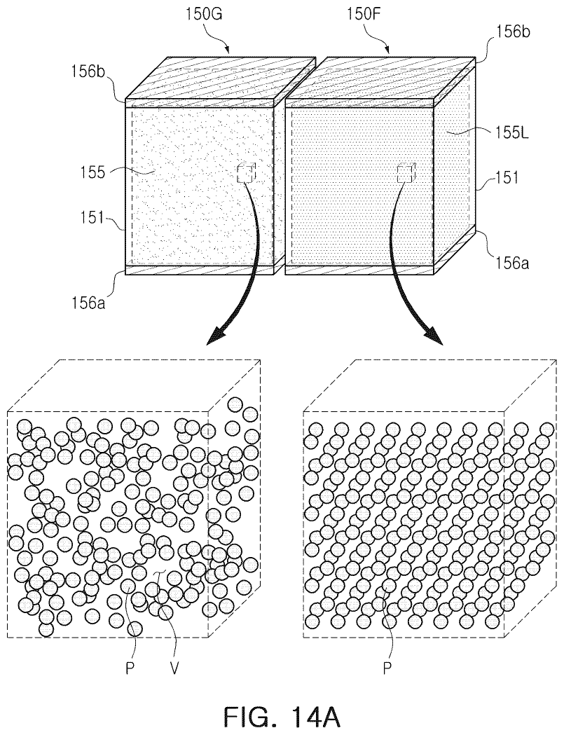

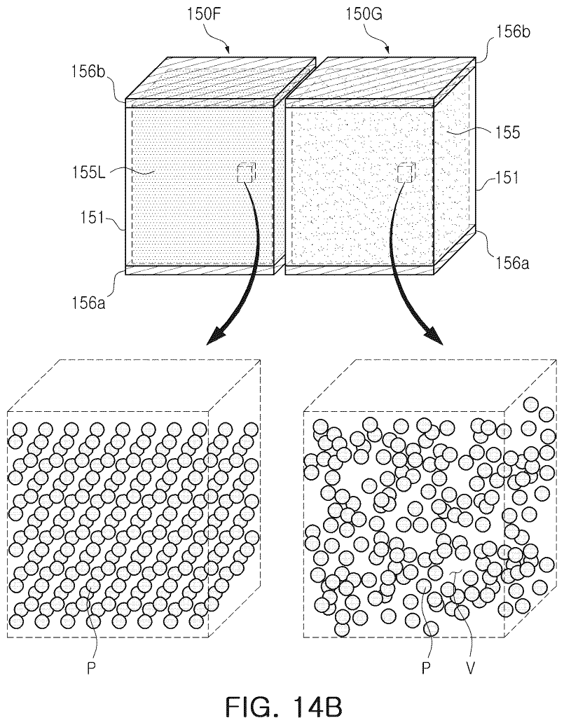

Referring to FIGS. 14A and 14B, the first and second acoustic sensors 150F and 150G installed in the first and second windows EW1 and EW2, respectively, may function as electrically independent sensors by configuring the piezoelectric material together with the first and second electrodes 156a and 156b to be separated from each other. In some implementations, the first and second acoustic sensors 150F and 150G may be provided as a single structurally integrated assembly.

The first acoustic sensor 150F located on the first and second internal tracks T1a and T1b may be the low-sensitivity acoustic sensor described above with reference to FIG. 10B, and the second acoustic sensor 150G located on the second and third tracks T2 and T3 may be the high-sensitivity acoustic sensor described above with reference to FIG. 10A. In addition, the first acoustic sensor 150F is illustrated as having a crystallized piezoelectric body, but an acoustic sensor having a relatively low sensitivity may be manufactured to include a porous piezoelectric structure having a different porosity.

According to the above-described examples, the porous piezoelectric structure is provided with a sufficient volume to reduce an empty space of the hole in which the acoustic sensor is located, so that sound waves generated during the polishing process may be effectively transmitted to the acoustic sensor. In addition, since the porous piezoelectric structure has a predetermined porosity, the piezoelectric coefficient of the acoustic sensor may increase and the amount of generated charges may increase, thereby significantly improving the sensitivity of the sensor.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While examples have been illustrated and described above, it will be apparent to those skilled in the art that modifications and variations could be made without departing from the scope of the present inventive concept as defined by the appended claims.

What is claimed is:

1. A chemical mechanical polishing apparatus comprising:
a polishing platen;
a polishing pad disposed on an upper surface of the polishing platen;
a polishing head disposed on the polishing pad and configured to support a wafer contacting an upper surface of the polishing pad, the upper surface of the polishing pad defining a hole on a path through which the polishing head passes on the upper surface of the polishing pad;
an acoustic sensor disposed in the hole of the polishing pad and including a porous piezoelectric structure formed of piezoelectric particles and first and second electrodes connected to the porous piezoelectric structure; and
a processor configured to detect a polishing endpoint based on acoustic signals received from the first and second electrodes of the acoustic sensor.

2. The chemical mechanical polishing apparatus of claim 1, wherein the porous piezoelectric structure includes a plurality of piezoelectric layers stacked in a thickness direction of the polishing pad, and
wherein the plurality of piezoelectric layers include piezoelectric particles having different porosities.

3. The chemical mechanical polishing apparatus of claim 2, wherein the plurality of piezoelectric layers include a first piezoelectric layer having a first porosity and a second piezoelectric layer disposed on the first piezoelectric layer and having a second porosity lower than the first porosity.

4. The chemical mechanical polishing apparatus of claim 2, wherein the plurality of piezoelectric layers include a first piezoelectric layer having a first porosity and a second piezoelectric layer disposed on the first piezoelectric layer and having a second porosity higher than the first porosity.

5. The chemical mechanical polishing apparatus of claim 2, wherein the plurality of piezoelectric layers include piezoelectric particles of different sizes.

6. The chemical mechanical polishing apparatus of claim 2, wherein the plurality of piezoelectric layers include piezoelectric particles having a same size.

7. The chemical mechanical polishing apparatus of claim 1, wherein the hole is one of a plurality of holes arranged on the path in a radial direction of the upper surface of the polishing pad, and
wherein the acoustic sensor includes a plurality of acoustic sensors respectively disposed in the plurality of holes.

8. The chemical mechanical polishing apparatus of claim 7, wherein the plurality of holes include a first hole adjacent to a center of the path and a second hole and a third hole respectively adjacent to inner and outer peripheries of the path, and
wherein the plurality of acoustic sensors include first to third acoustic sensors respectively disposed in the first to third holes.

9. The chemical mechanical polishing apparatus of claim 8, wherein the first acoustic sensor includes a first piezoelectric layer having a first porosity, and
wherein the second and third acoustic sensors include second and third piezoelectric layers respectively having second and third porosities greater than the first porosity.

10. The chemical mechanical polishing apparatus of claim 8, wherein the first acoustic sensor includes a first piezoelectric layer having a first porosity, and
wherein the second and third acoustic sensors include second and third piezoelectric layers respectively having second and third porosities lower than the first porosity.

11. The chemical mechanical polishing apparatus of claim 1, wherein the hole is one of a plurality of holes including at least one expansion hole extending in a radial direction of the upper surface of the polishing pad on the path, and
wherein the acoustic sensor includes a plurality of acoustic sensors arranged in the radial direction in the at least one expansion hole.

12. The chemical mechanical polishing apparatus of claim 11, wherein the plurality of acoustic sensors include piezoelectric layers having different porosities.

13. The chemical mechanical polishing apparatus of claim 1, wherein the polishing pad includes a window acoustically coupled to the acoustic sensor, and the window has an upper surface being substantially coplanar with the upper surface of the polishing pad within the hole.

14. The chemical mechanical polishing apparatus of claim 1, wherein the acoustic sensor includes a housing surrounding the porous piezoelectric structure within the hole.

15. The chemical mechanical polishing apparatus of claim 1, wherein the first and second electrodes are respectively disposed on lower and upper surfaces of the porous piezoelectric structure, and
wherein at least the second electrode includes a conductive polymer layer.

16. The chemical mechanical polishing apparatus of claim 1, wherein the first and second electrodes are respectively disposed on two opposing sides of the porous piezoelectric structure.

17. A chemical mechanical polishing apparatus comprising:
a polishing platen;
a polishing pad disposed on an upper surface of the polishing platen;
a polishing head disposed on the polishing pad and configured to support a wafer contacting an upper surface of the polishing pad, the upper surface of the polishing pad defining a plurality of holes arranged in a radial direction of the polishing pad on a path through which the polishing head passes on the upper surface of the polishing pad;
a plurality of acoustic sensors respectively disposed in the plurality of holes, respectively including a porous piezoelectric layer including piezoelectric particles and first and second electrodes connected to the porous piezoelectric layer; and
a processor configured to detect a polishing endpoint based on acoustic signals received from the plurality of acoustic sensors.

18. The chemical mechanical polishing apparatus of claim 17, wherein the plurality of holes include a first hole adjacent to a center of the path and a second hole and a third hole respectively adjacent to inner and outer peripheries of the path, and
wherein the plurality of acoustic sensors include first to third acoustic sensors respectively disposed in the first to third holes, and the first to third acoustic sensors have porous piezoelectric layers having different porosities.

19. The chemical mechanical polishing apparatus of claim 18, wherein the porous piezoelectric layer of the first acoustic sensor has a first porosity, and
wherein the second and third acoustic sensors each have a second and third porosity greater than the first porosity.

20. A chemical mechanical polishing apparatus comprising:
a polishing platen;
a polishing pad disposed on an upper surface of the polishing platen;
a polishing head disposed on the polishing pad and configured to support a wafer contacting an upper surface of the polishing pad, the upper surface of the polishing pad defining a hole disposed on a path through which the polishing head passes on the upper surface of the polishing pad;
an acoustic sensor disposed in the hole of the polishing pad and including a porous piezoelectric structure having a plurality of piezoelectric layers stacked in a thickness direction of the polishing pad and having different porosities and first and second electrodes connected to the porous piezoelectric structure; and
a processor configured to detect a polishing endpoint based on acoustic signals received from the first and second electrodes of the acoustic sensor.
